(19) United States
(12) Patent Application Publication
(10) Pub. No.: US 2022/0004012 A1
(43) Pub. Date: Jan. 6, 2022

(54) VARIABLE RESOLUTION AND AUTOMATIC WINDOWING FOR LIDAR

(71) Applicant: Seagate Technology LLC, Fremont, CA (US)

(72) Inventors: Eric Dahlberg, Eden Prairie, MN (US); Kevin A. Gomez, Eden Pairie, MN (US); Mazbeen J. Palsetia, Prior Lake, MN (US); Riyan A. Mendonsa, Edina, MN (US)

(21) Appl. No.: 16/921,151

(22) Filed: Jul. 6, 2020

(51) Int. Cl. G02B 27/09; G01S 7/481; G02B 26/12; G01S 17/89

(52) U.S. Cl. CPC G02B 27/0983; G01S 17/89; G02B 26/126; G01S 7/4817

(57) ABSTRACT

A beam steering control system includes a beam angle controller, a fast axis controller configured to receive a first command signal from the beam angle controller and configured to control a first axis component of a light pattern, and a slow axis controller arranged within a closed-loop system. The slow axis controller is configured to receive a second command signal from the beam angle controller and control a second axis component of the light pattern.

### SUMMARY

In certain embodiments, a beam steering control system includes a beam angle controller, a fast axis controller configured to receive a first command signal from the beam angle controller and configured to control a first axis component of a light pattern, and a slow axis controller arranged within a closed-loop system. The slow axis controller is configured to receive a second command signal from the beam angle controller and control a second axis component of the light pattern.

In certain embodiments, a method includes determining a size and a position of a region of interest in terms of a first coordinate system at a first point in time. The method further includes—based on position data in terms of a second coordinate system associated with a measurement device with a light source—determining the position of the region of interest in terms of the first coordinate system at later points in time. The method further includes steering emitted light from the light source within the region of interest at the later points in time.

In certain embodiments, a method for generating a light pattern is disclosed. The method includes measuring a timing from a beginning of a horizontal scan line to an end of the horizontal scan line, which comprises light pulses. The method further includes counting down a delay until a next light pulse; when the delay counter reaches zero, firing a light pulse from a light source; defining windows of time for a given scan; defining a priority hierarchy for active windows for a particular timer count; and, for active windows, set a light fire delay to a specified rate.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 shows a schematic, cut-away view of a LIDAR device with a rotating mirror and a curved mirror, in accordance with certain embodiments of the present disclosure.

FIG. 2 shows a perspective view of a reflecting apparatus and a motor, in accordance with certain embodiments of the present disclosure.

FIG. 3 shows a schematic, perspective view of the LIDAR device of FIG. 1 and an example light pattern generated by the LIDAR device, in accordance with certain embodiments of the present disclosure.

FIG. 4 shows a perspective view of a curved mirror, in accordance with certain embodiments of the present disclosure.

FIG. 5 shows a block diagram of a beam steering control system, in accordance with certain embodiments of the present disclosure.

FIG. 6 shows schematics of the LIDAR device of FIG. 1 and a vehicle along with their respective coordinate systems, in accordance with certain embodiments of the present disclosure.

FIG. 7 shows a block diagram of steps of a method, in accordance with certain embodiments of the present disclosure.

FIGS. 8A-D show various light patterns that can be created by the LIDAR device 100 of FIG. 1 in connection with the beam steering control system of FIG. 5, in accordance with certain embodiments of the present disclosure.

While the disclosure is amenable to various modifications and alternative forms, specific embodiments have been shown by way of example in the drawings and are described in detail below. The intention, however, is not to limit the disclosure to the particular embodiments described but instead is intended to cover all modifications, equivalents, and alternatives falling within the scope of the appended claims.

### DETAILED DESCRIPTION

Certain embodiments of the present disclosure relate to measurement devices and techniques, particularly, measurement devices and techniques for light detection and ranging, which is commonly referred to as LIDAR, LADAR, etc. LIDAR devices can be used with vehicles such as autonomous or semi-autonomous vehicles. For example, LIDAR devices can transmit pulsed light from a vehicle and that pulsed light may be reflected back from objects surrounding the vehicle. The reflected light is detected by sensors (e.g., optical sensors such as photodetectors), which in turn generate sensor signals. The sensor signals are used by the LIDAR devices (or separate data processing devices) to determine the distance between the LIDAR devices and the object(s) that reflected the light. Thus, the sensor signals are used to detect objects around the vehicle.

When an object is detected, the LIDAR devices may direct more light to a region of interest where the object was detected to increase the resolution of the LIDAR system. However, in the case of moving vehicles, the frame of reference of the LIDAR device itself may be constantly changing. As such, it can be challenging to direct the increased light as desired. Certain embodiments of the present disclosure are according directed to LIDAR systems, methods, and devices that can steer light to a target region of interest.

### Lidar Device

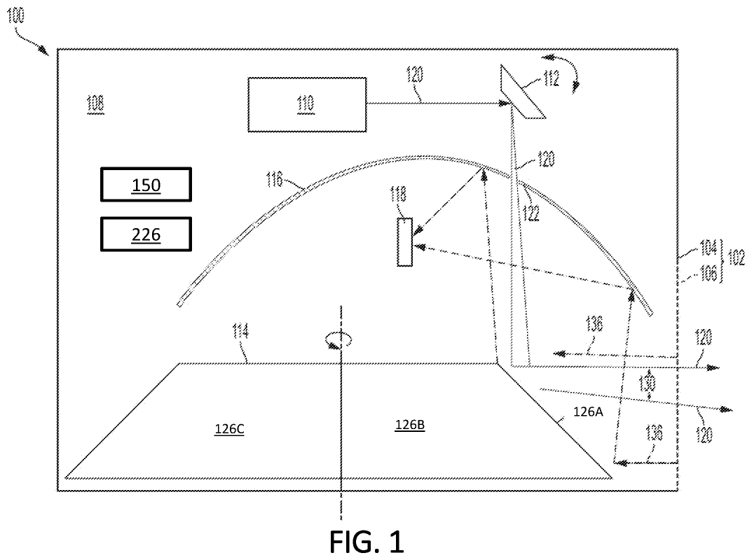

FIG. 1 shows a schematic of a LIDAR device 100 (e.g., a LIDAR/LADAR device, which is hereinafter referred to as “the LIDAR device 100”) including a housing 102 with a base member 104 and a cover 106. The base member 104 and the cover 106 can be coupled together to surround an internal cavity 108 in which various components of the LIDAR device 100 are positioned. In certain embodiments, the base member 104 and the cover 106 are coupled together to create an air and/or water-tight seal. For example, various gaskets or other types of sealing members can be used to help create such seals between components of the housing 102. The base member 104 can comprise materials such as plastics and/or metals (e.g., aluminum). The cover 106 can comprise, in whole or in part, transparent materials such as glass or sapphire. In certain embodiments, various components of the housing 102 is coated with an anti-reflective coating.

For simplicity, the housing 102 in FIG. 1 is shown with only the base member 104 and the cover 106, but the housing 102 can comprise any number of components that can be assembled together to surround the internal cavity 108 and secure components of the LIDAR device 100. Further, the base member 104 may be machined, molded, or otherwise shaped to support the components of the LIDAR device 100. The features of the LIDAR device 100 are not necessarily drawn to scale. The figures are intended to show examples of how the features of the LIDAR devices can be arranged to create scanning patterns of light that are emitted from and scattered back to the LIDAR devices. For example, the figures show how the features of the LIDAR devices are physically arranged with respect to each. Further, the figures show example arrangements of optical elements within optical paths that create patterns of light and detect light scattered back to the LIDAR devices.

The LIDAR device 100 includes a light source 110, a rotatable mirror 112 (e.g., a mirror-on-a-chip, electro-thermal-actuated mirror, or the like), a reflecting apparatus 114 (e.g., a rotatable pyramidal-shaped mirror), a focusing apparatus 116 (e.g., a lens or a parabolic mirror), and a detector 118 (e.g., a sensor).

The light source 110 can be a laser (e.g., laser diodes such as VCSELs and the like) or a light-emitting diode configured to emit coherent light. In certain embodiments, the light source 110 emits light (e.g., coherent light) within the infrared spectrum (e.g., 905 nm and 1515 nm frequencies are non-limiting examples) while in other embodiments the light source 110 emits light within the visible spectrum (e.g., 485 nm frequency as a non-limiting example). In certain embodiments, the light source 110 is configured to emit light in pulses.

The light emitted by the light source 110 is directed towards the reflecting apparatus 114. The emitted light and its direction are represented in FIG. 1 by arrows 120. In certain embodiments, the emitted light 120 is first directed towards the rotatable mirror 112, which reflects the light towards the reflecting apparatus 114. The rotatable mirror 112 can be a silicone-based Micro Electro Mechanical Systems (MEMS) mirror, which is sometimes referred to as a mirror-on-a-chip. The rotatable mirror 112 can rotate around an axis such that the emitted light is scanned back and forth along a line. Put another way, the rotatable mirror 112 can be used to steer the emitted light 120 along a line and towards the reflecting apparatus 114. As shown in FIG. 1, the rotatable mirror 112 is angled at a nominal angle of 45 degrees with respect to the emitted light 120 from the light source 110 such that the emitted light 120 is reflected at a nominal angle of 90 degrees. In certain embodiments, the rotatable mirror 112 is configured to rotate around the axis within ranges such as 1-20 degrees, 5-15 degrees, and 8-12 degrees. Using a 10-degree range of rotation as an example, the emitted light 120 would be reflected back and forth between angles of 85 degrees and 95 degrees as the rotatable mirror 112 rotates back and forth within its range of rotation. As will be described in more detail below, the range of rotation affects the extent or displacement of the line scan created by the rotatable mirror 112.

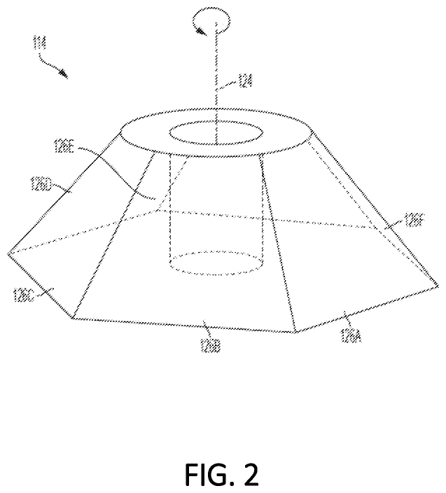

In certain embodiments, the emitted light 120 reflected by the rotatable mirror 112 (which creates a line scan over time) passes through an aperture 122 in the focusing apparatus 116 towards the reflecting apparatus 114. An exemplary reflecting apparatus 114 is shown in FIG. 2 and can be described as a six-sided (or hexagonal) pyramidal-shaped rotating mirror. The reflecting apparatus 114 can be at least partially created using three-dimensional printing, molding, and the like. The reflecting apparatus 114 is coupled to a cylindrical-shaped motor 124 that rotates the reflecting apparatus 114 during operation of the measurement device 100. Increasing rotational speed of the motor 124 (and therefore the rotational speed of the reflecting apparatus 114) increases the sampling rate of the LIDAR device 100 but also increases the power consumed by the LIDAR device 100. The motor 124 can be a fluid-dynamic-bearing motor, a ball-bearing motor, and the like. Although the motor 124 is shown as being centrally positioned within the reflecting apparatus 114, the reflecting apparatus 114 can be rotated via other means, including means other than the motor 124 shown in FIG. 2.

The reflecting apparatus 114 comprises a plurality of facets/faces 126A-F. Each facet 126A-F includes or otherwise incorporates a reflective surface such as a mirror. For example, a mirror can be attached to each facet 126A-F of the reflecting apparatus 114. Although the reflecting apparatus 114 is shown and described as having six facets at an approximately 45-degree angle, the reflecting apparatus can have fewer or more facets (e.g., 3-5 facets, 7-24 facets) at different angles (e.g., 30-60 degrees). The number of facets affects the displacement of the emitted light 120. For example, as the reflecting apparatus 114 rotates, the emitted light 120 directed towards the reflecting apparatus 114 will be reflected and scanned along a line. The overall displacement of the line is dependent on the number of facets on the reflecting apparatus 114. When the reflecting apparatus 114 includes six facets, 126A-F, the resulting line that the emitted light 120 is scanned along has a displacement of sixty degrees (i.e., 360 degrees divided by the number of facets, which is six). This displacement affects the field of view of the measurement device 100.

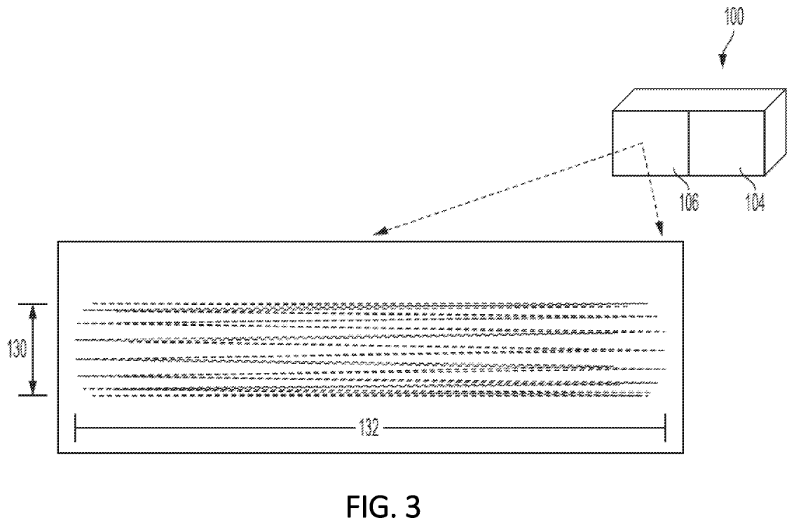

When the scan line created by the rotatable mirror 112 is reflected by the rotating reflective apparatus 114, a resulting light pattern 128 or light path is created, similar to that shown in FIG. 3. The light pattern 128 has a vertical component 130 and a horizontal component 132 that makeup the field of view of the LIDAR device 100. The horizontal component 132 (or displacement) portion of the light pattern 128 is created by the rotating reflective apparatus 114, and the vertical component 130 is created by the rotatable mirror 112. When the rotatable mirror 112 rotates within a 10-degree range of angles and the reflecting apparatus 114 includes six facets 126A-F, the vertical component 130 of the light pattern 128 is 10 degrees and the horizontal component 132 is 60 degrees. As such, the LIDAR device 100 can be said to have a 10-degree by 60-degree field of view.

The emitted light 120 is transmitted out of the housing 102 (e.g., through the translucent cover 106) of the LIDAR device 100 towards objects. A portion of the emitted light reflects off the objects and returns through the cover 106. This light, referred to as backscattered light, is represented in FIG. 1 by multiple arrows 136 (not all of which are associated with a reference number in FIG. 1). In certain embodiments, the backscattered light 136 is reflected by the same facet on the reflecting apparatus 114 that the emitted light 120 reflected against before being transmitted out of the housing 102. After being reflected by the reflecting apparatus 114, the backscattered light 136 is focused by the focusing apparatus 116.

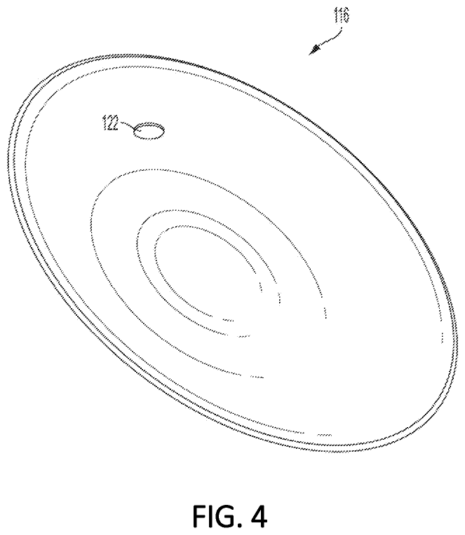

The focusing apparatus 116 is an optical element that focuses the backscattered light 136 towards the detector 118. For example, the focusing apparatus 116 can be a lens or a curved mirror such as a parabolic mirror. FIG. 1 shows the focusing apparatus 116 as a parabolic mirror with its focal point positioned at the detector 118. FIG. 4 shows a perspective view of the focusing apparatus 116 in the shape of a parabolic mirror extending around a full 360 degrees. The particular shape, size, position, and orientation of the focusing apparatus 116 in the measurement device 100 can depend on, among other things, the position of the detector(s) 118, where the path(s) at which backscattered light 136 is directed within the housing 102, and space constraints of the LIDAR device 100.

In certain embodiments, the focusing apparatus 116 focuses the backscattered light 136 to the detector 118, such as one or more photodetectors/sensors arranged in one or more arrays. The detector 118 can be positioned at the focal point of the focusing apparatus 116. In response to receiving the focused backscattered light, the detector 118 generates one or more sensing signals, which are ultimately used to detect the distance and/or shapes of objects that reflect the emitted light 120 back towards the LIDAR device 100 and ultimately to the detector 118.

In certain embodiments, the LIDAR device 100 can generate multiple light patterns. For example, the LIDAR device 100 can include multiple light sources or include a beam splitter to create multiple light paths from a single light source. In such embodiments, each light beam would be directed towards separate facets on the reflecting apparatus 114. Using a six-faceted reflecting apparatus 114 as an example, a measurement device that directs light to two of the reflecting apparatus's facets would have either a 120-degree horizontal field of view or up to two separate 60-degree horizontal fields of view. For a 360-degree horizontal field of view, a measurement device could include six separate light beams (via multiple light sources and/or one or more beam splitters) each reflecting off a separate facet of the rotating apparatus 114.

As noted above, when an object is detected, the LIDAR device 100 may direct more emitted light 120 to a region of interest within its field of view and where the object was detected. Directing more of the emitted light 120 to the region will increase the resolution of the LIDAR system in that region which will increase the accuracy of the LIDAR system in that region. Put another way, as will be described in more detail below, the LIDAR device 100 may direct more light by allocating more light pulses by decreasing the distance or spacing between scan lines and/or increasing the rate at which the light source 110 emits pulses of light.

The resolution in the vertical component 130 of the light pattern 128 can be increased by decreasing the rate at which the rotatable mirror 112 rotates (or by effecting a change in the scanning rate along the vertical component 130 via another component for LIDAR devices without a rotating mirror). Decreasing the scanning rate along the vertical component 130 will increase the amount of the emitted light 120 that is directed to a given area over time.

The resolution in the horizontal component 132 of the light pattern 128 can be increased by increasing the fire or pulse rate of the light source 110 and/or by decreasing the speed at which the motor 124 rotates the reflecting apparatus 114 (or by effecting a change in the scanning rate along the horizontal component 132 via another component for LIDAR devices without a reflecting apparatus described above).

In the case of moving vehicles, the frame of reference of the LIDAR device 100 may be constantly changing. As such, it can be challenging to direct increased resolution in a desired region or area where a detected object is traveling or has traveled.

### Control System

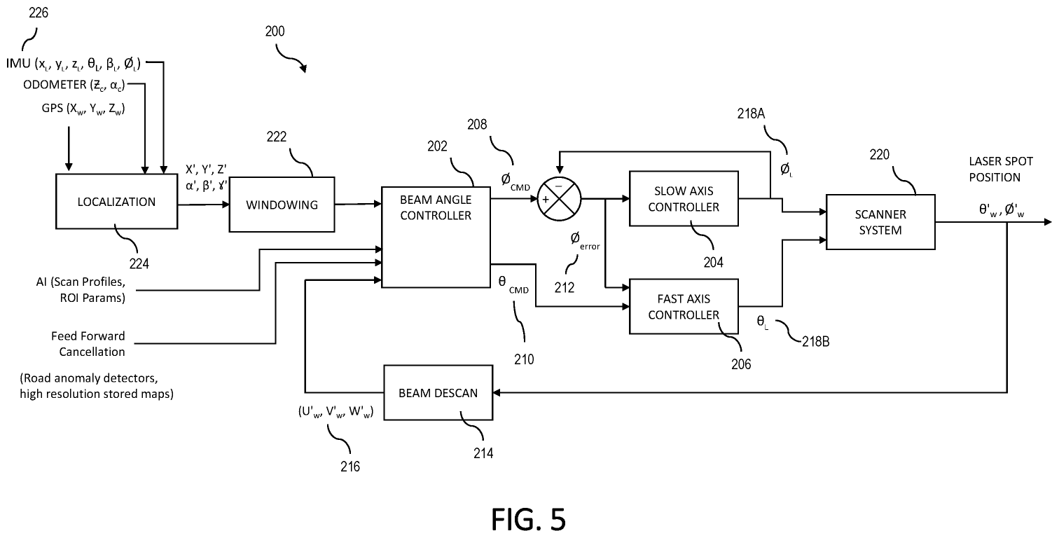

FIG. 5 shows a schematic of a beam steering control system 200 (hereinafter “the control system 200”) that can be used by the LIDAR device 100 to steer the emitted light 120 to a target region of interest when the LIDAR device 100 and the detected object are moving relative to each other. Put another way, when the frame of reference of the LIDAR device 100 changes, the control system 200 can dynamically change or update the region of focus of the LIDAR device 100. Although the control system 200 is described below in connection with the LIDAR device 100 of FIG. 1 and its components, the control system 200 can be used with LIDAR devices with different types of components. For example, while the LIDAR device 100 described above is a mechanical LIDAR device, the control system 200 can be used by a solid-state LIDAR device. In certain embodiments, the control system 200 is implemented on circuitry of the LIDAR device 100. For example, the control system 200 may be implemented in one or more integrated circuits 150 (shown in FIG. 1) such as a system-on-a-chip (SOC) on the LIDAR device 100. The one or more integrated circuits 150 can be communicatively coupled to the various components of the LIDAR device 100 to effect changes in, for example, the pulse rate of the light source 110, the rotation rate of the rotatable mirror 112, the rotation rate of the motor 124 (and therefore the reflecting apparatus 114), etc.

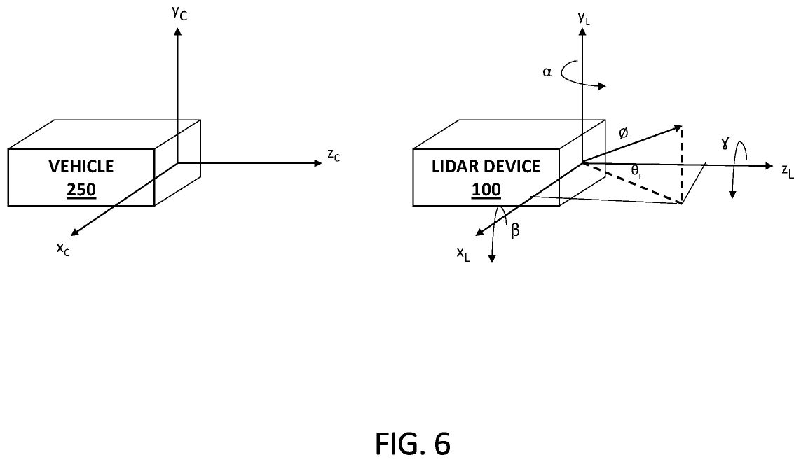

FIG. 6 shows a schematic of the LIDAR device 100 and its coordinate system. FIG. 6 also shows a schematic of a vehicle 250 and its coordinate system. Various components of the coordinate systems are discussed below in the context of the control system 200 of FIG. 5.

The control system 200 includes a beam controller 202 that, in response to various inputs, controls a slow axis controller 204 and a fast axis controller 206. In certain embodiments, the inputs to the beam controller 202 include position data from various sensors (e.g., inertial measurement unit, vehicle odometer, global positioning system, vibration sensors), digital maps, and/or scan profiles. In certain embodiments, the scan profiles are generated by artificial intelligence engines in response to receiving and processing the backscattered light 136 such that the scan profiles direct the emitted light within a targeted region of interest.

The beam controller 202 and the other controllers in the control system 200 can include at least one processor that executes software and/or firmware stored in memory. The software/firmware code contains instructions that, when executed by the processor, cause the controllers to perform the functions described herein. The controllers may alternatively or additionally include or take the form of one or more application-specific integrated circuits (ASICs), field-programmable gate arrays (FPGAs), digital signal processors (DSPs), hardwired logic, or combinations thereof.

The “slow axis” in the LIDAR device 100 is the vertical axis of the light pattern 128 (e.g., the “y” axis of the LIDAR device 100 shown in FIG. 6) because rate at which the emitted light 122 traverses a given length along the vertical axis is slower than the rate the emitted light 122 traverses the given length along the horizontal axis (e.g., the “x” axis of the LIDAR device 100 shown in FIG. 6). In the context of the LIDAR device 100, the slow axis controller 204 controls the rotatable mirror 112 while the fast axis controller 206 controls the pulse rate of the light source 110 and/or the reflecting apparatus 114.

The beam controller 202 generates slow axis commands 208 that are communicated to the slow axis controller 204 and generates fast axis commands 210 that are communicated to the fast axis controller 206. As shown in FIG. 5, the slow axis controller 204 is a closed-loop controller or can be considered to be part of a closed-loop sub-system within the control system 200. The slow axis controller 204 will attempt to use its closed loop gain to attenuate disturbances. For example, the slow axis controller 204 will attempt to stabilize the vertical scan with respect to a target to compensate for disturbances (e.g., shock and vibration) imposed on the LIDAR device 100. Put another way, when a disturbance causes the LIDAR device 100 to be “off track” in the vertical direction, the slow axis controller 204 can compensate for the disturbance and attempt to position (e.g., via the rotatable mirror 112) the emitted light 120 back on the desired path of the light pattern.

If the slow axis controller 204 cannot correct for all error, a remaining error signal 212 is communicated to the fast axis controller 206. In certain embodiments, the fast axis controller 206 can be considered to be a zero-mass timing system that is able to respond within sub-nanosecond or nanosecond ranges to apply corrections in response to the remaining error signal 212. In certain embodiments, the fast axis controller 206 can compensate for error in the yaw axis. For example, the fast axis controller 206 can attempt to control the pulse rate of the light source 100 to correct for disturbances in the yaw axis (e.g., rotational vibration).

Additional remaining error can be corrected (or at least attempted to be corrected) by a de-scanning system 214. For example, the de-scanning system 214 can de-scan the estimated spot position rather than the commanded or measured spot position. The de-scanning system 214 can output a position signal 216 that is inputted to the beam controller 202.

The slow axis controller 204 and the fast axis controller 206 can output respective control signals 218A and 218B that are communicated as inputs to a scanner system 220. The scanner system 220 calculates a vertical position and a horizontal position of a center of the target region of interest. This calculated vertical and horizontal position is in coordinates of a world frame of reference or coordinate system, which is described in more detail below.

### Method for Increasing Resolution

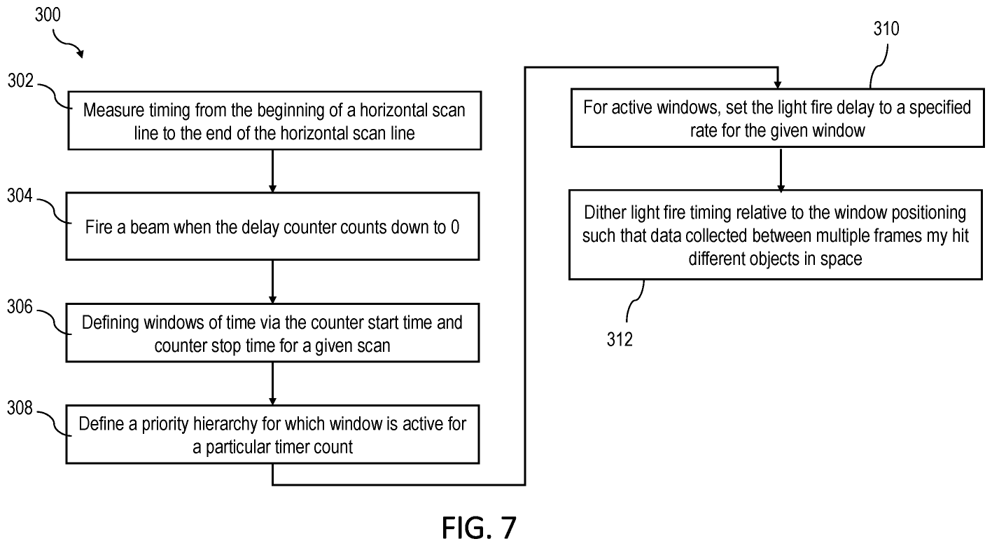

As noted above, the pulse rate of the light source 110 can be controlled to change the resolution in the horizontal component 132 of the light pattern 128. FIG. 7 outlines steps of a method 300 for controlling the pulse rate of the light source 110 within the target region of interest.

The method 300 includes measuring the timing from the beginning of a horizontal scan line to the end of the horizontal scan line (block 302 in FIG. 7). For example, with the reflecting apparatus 114, the horizontal scan line would begin as the emitted light hits one edge of one of the facets 126A-F and would end at the other edge of the given facet.

The method 300 further includes maintaining a parameter that indicates the delay until the next light fire (e.g., the timing between light pulses). When the delay counter counts down to 0, the light source 110 fires (block 304 in FIG. 7). The method 300 further includes defining windows of time via the counter start time and the counter stop time for a given scan (block 306 in FIG. 7). The light fire delay may be a function of scan start time to scan end time, such that a fixed resolution is possible regardless of changes in scan start time to scan end time.

Next, a priority hierarchy is defined for which window is active for a particular timer count (block 308 in FIG. 7). For active windows, the light fire delay is set to a specified rate for the given window (block 310 in FIG. 7). The light fire timing relative to the window positioning may be dithered such that data collected between multiple frames my hit different objects in space (block 312 in FIG. 7).

### Steering Emitted Light to Region of Interest Over Time

As noted above, in the case of moving vehicles, the frame of reference of the LIDAR device 100 may be constantly changing. When an object in the LIDAR device's field of view is detected and a region of interest is identified, it can be challenging to steer the emitted light at the desired region of interest over time (e.g., from scene to scene) because the detected object may be moving within the LIDAR device's field of view over time as the LIDAR device 100 is also moving itself. The description below explains how the control system 200 of FIG. 5—in the context of the coordinate systems of FIG. 6—can be used to steer the emitted light of the LIDAR device 100 to a target region of interest over time.

The control system 200 includes a windowing control block 222 that is used to control the position of resolution windows within the LIDAR device's field of view. In certain embodiments, instead of a separate windowing control block 222, the beam angle controller 202 includes the control logic for the approaches described below.

As shown in FIG. 5, the windowing control block 222 can receive position data from a localization block 224. The position data can be from three different coordinate systems. One coordinate system is the coordinate system of the LIDAR device 100. The second coordinate system is the coordinate system of the vehicle 250. And, the third coordinate system is the global or world coordinate system.

The position data for the coordinate system of the LIDAR device 100 can be generated by an inertial measurement unit (IMU) 226 that is part of (e.g., integral) or otherwise communicatively coupled to the LIDAR device 100. The IMU 226 can generate position data for the x-axis, y-axis, z-axis, pitch, roll, and yaw of the LIDAR device 100. The position data for the coordinate system of the vehicle 250 can be generated by the vehicle's odometer. The position data for the coordinate system of the world can be generated by a global positioning system (GPS).

The windowing control block 222 can receive the position data generated by the various sources and translate between the different coordinate systems. For example, as will be described in more detail below, the windowing control block 222 can first receive position data from the IMU 226 indicating a change in orientation/position from scene to scene in the coordinate system of the LIDAR device 100. The windowing control block 222 can translate the change in orientation/position from the LIDAR device's coordinate system to terms of the coordinate systems of the vehicle 250 and/or the world coordinate system.

Once one or more objects are detected or one or more regions of interest are otherwise determined, the windowing control block 222 can determine a position of a window or windows within the LIDAR device's frame of reference that is coincident with the targeted region(s) of interest. For example, the windowing control block 222 can automatically position a window that is coincident with the targeted region of interest by using position data of the IMU 226. Then, the control system 200 can control the LIDAR device 100 to steer the emitted light to the targeted region of interest.

Put another way, once the initial dimensions and the position of the targeted region of interest are determined, the control system 200 can adjust the positioning of the windows such that the LIDAR device 100 continues to steer the emitted light to the same or substantially the same region of space—even as the LIDAR device's frame of reference changes relative to the world frame of reference. In addition, the control system 200 can adjust the resolution (e.g., sampling resolution) and the size of the window based on the travel distance of the LIDAR device 100.

Below are terms that help further explain the translation of the position data and window data between the LIDAR device 100 coordinate system and the world coordinate system. The “L” subscripts represent position data within the coordinate system of the LIDAR device 100, and the “W” subscripts represent position data within the world coordinate system.

F_{L}(t₀)=LiDAR frame position at time 0

W(t₀)=f(h_{W},w_{W},θ_{W},φ_{W},r_{H},r_{V})=Window at time 0, which is a function of

h_{W}=window height

w_{W}=window width

θ_{W}=window horizontal angular offset

φ_{W}=window vertical angular offset

r_{H}, r_{V}=window horizontal and vertical resolution respectively

The transformation operator, T(tₙ), is a function of the position data within the coordinate system of the LIDAR device 100 and serves as a map from W(t₀) to W(t_{N}):

T(t_{N})=h(x_{L},y_{L},z_{L},α_{L},β_{L},γ_{L})

At t₀, a command specifying the window, W(t₀), is issued in response to a target region of interest being determined. In certain embodiments, the initial dimensions and the position of the targeted region of interest is not determined by the control system 200 or the LIDAR device 100 themselves but instead is determined by a host system that controls multiple control systems 200 and/or LIDAR devices 100 of the vehicle 250. The host system can be a computing device with one or more processors (e.g., microprocessors, graphics processing units) that are configured to determine when objects are within the LIDAR device's field of view. In response to detecting objects, the host system can be configured to issue commands to the control system 200 and/or the LIDAR device 100 regarding the dimensions and the position of the window.

In response to the window command from the host system, the control system 200 (e.g., via the beam angle controller 202) causes the emitted light 120 to be steered such that resolution is increased within the window.

At later points in time (e.g., tₙ), the control system 200 (e.g., via the windowing control block 222 or the beam angle controller 202) performs the above-described automatic windowing by performing a transformation on the window at to (e.g., W(t₀)) via T(t_{N}). As such, W(t_{N})=T(t_{N})W(t₀).

In constructing the transformation operator T(t_{N}), the terms x_{L},y_{L},z_{L},θ_{L},φ_{L},γ_{L} may be obtained or approximated via a variety of localization techniques via the localization block 224. As noted above, the localization block 224 can receive position data from the IMU 226, vehicle 250, and/or a GPS. Additionally, the localization block 224 can receive other data such as sensor data/signals from vibration sensors and the like. In certain embodiments, the transformation operator T(t_{N}) is construed when complete localization data is not available. For example, even if x_{L}, y_{L}, z_{L} are not known, θ_{L}, φ_{L}, γ_{L} can be estimated via measurements or position data from the IMU 226. As such, the transformation operator T(t_{N}) may compute θ_{W}(t_{N}), φ_{W}(t_{N}) and leave the other parameters unchanged.

Because the control system 200 provides the translation between the LIDAR device's coordinate system and the world coordinate system—as opposed to the host system providing such translation—the control system 200 can reduce the amount of computational power used by the host system. Further, by utilizing position data from the IMU 226, the host system may not need as many sensors as otherwise would be required on the vehicle 250. Further yet, by utilizing position data from the IMU 226 to correct for disturbances, the LIDAR device 100 can be mounted to the vehicle 250 without requiring a separate stabilization platform.

### Light Patterns Created by Control System

As described above, the control system 200 has the ability to control the LIDAR device 100 to steer the emitted light within targeted regions of interest and to dynamically change resolution within the regions of interest. As such, the control system 200 can be used to create a variety of light patterns within the targeted regions of interest.

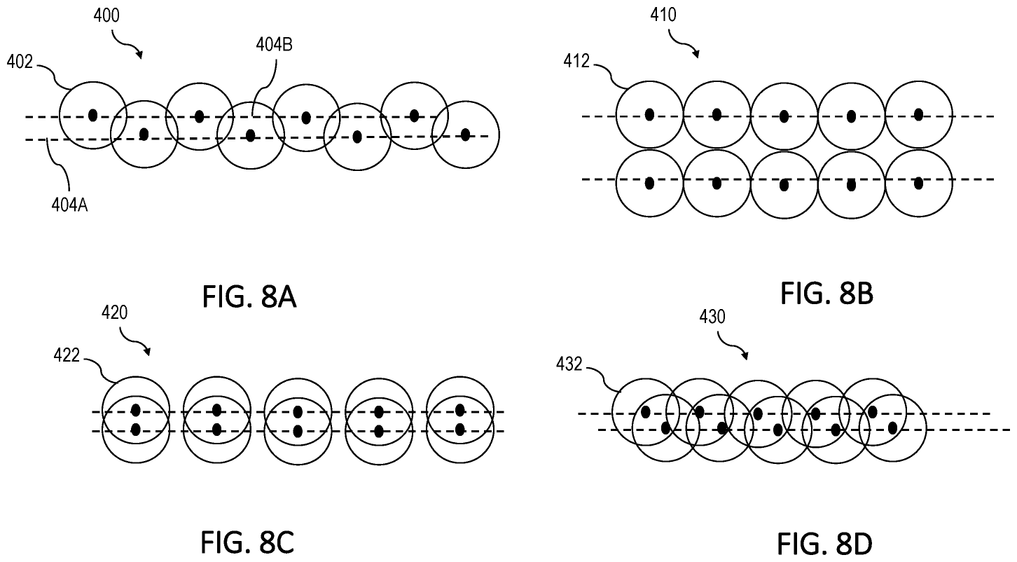

FIGS. 8A-D show different schematics of light patterns that can be created using the control system 200 and the LIDAR device 100. These various light patterns are examples of light patterns with increased resolution compared to typical light patterns used to scan in LIDAR systems. For example, in response to an object being detected or a region of interest identified, the control system 200 may implement one of these light patterns within the identified region of interest. The increased resolution can be accomplished by modifying, for example, the pulse rate of the emitted light and/or the scan rate along the vertical direction of the LIDAR device's field of view.

The larger circles in the light patterns represent the outer circumference of a pulsed light beam (e.g., a packet of photons). The filled-in circles in the middle of the larger circles represent the center of the packet of photons, and the dashed lines represent different scan lines along which the pulsed light is steered over time.

FIG. 8A shows a light pattern 400 where the pulsed emitted light beams 402 overlap vertically (e.g., over-scan in the vertical direction). For the vertical direction, the first scan line 404A and the second can line 404B are separated from each other a vertical distance such that the pulsed emitted light beams 402 overlap each other in the vertical direction. This can be created by reducing the scan rate in the vertical direction. For the horizontal direction, the pulsed emitted light beams 402 are pulsed at a rate and moved horizontally at a rate such that the pulsed emitted light beams 402 do not overlap each other in a given scan line. The pulsed emitted light beams 402 in the first scan line 404A are horizontally offset from the pulsed emitted light beams 402 in the second scan line 404B.

FIG. 8B shows a light pattern 410 with horizontal foveation. The pulsed emitted light beams 412 do not overlap each other in the vertical direction or the horizontal direction. But, the pulsed emitted light beams 412 are horizontally aligned with each other from scan line to scan line.

FIG. 8C shows a light pattern 420 of pulsed emitted light beams 422 that overlap vertically and that are aligned for horizontal foveation.

FIG. 8D shows a light pattern 430 of pulsed emitted light beams 432 that overlap each other in both the vertical direction and the horizontal direction.

### CONCLUSION

Using the above-described LIDAR system and its components (e.g., the LIDAR device 100, the control system 200), the accuracy is improved for targeting a moving object of interest across multiple scan lines or scan frames—even when both the LIDAR device 100 and the target are moving. For example, when the vehicle 250 is moving over a speed bump and is heading toward a ball rolling across a street, the LIDAR system can still increase (or concentrate) the amount of emitted light 120 (or photons) towards a region with the rolling ball. In addition to accuracy, using the above-described LIDAR system and its components can help optimize the number of sample points and power (e.g., light pulses) to be use for a particular region of space. As such, in the example of a rolling ball, higher resolution and/or power can be assigned to a region around the ball to improve the change that objects around the ball (e.g., someone chasing the ball in the street) will be detected.

Various modifications and additions can be made to the embodiments disclosed without departing from the scope of this disclosure. For example, while the embodiments described above refer to particular features, the scope of this disclosure also includes embodiments having different combinations of features and embodiments that do not include all of the described features. Accordingly, the scope of the present disclosure is intended to include all such alternatives, modifications, and variations as falling within the scope of the claims, together with all equivalents thereof.

We claim:

1. A beam steering control system comprising:
a beam angle controller;
a fast axis controller configured to receive a first command signal from the beam angle controller and configured to control a first axis component of a light pattern; and
a slow axis controller arranged within a closed-loop system and configured to:
receive a second command signal from the beam angle controller, and
control a second axis component of the light pattern.

2. The beam steering control system of claim 1, wherein the fast axis controller is communicatively coupled to a light source and/or a motor, wherein the fast axis controller is configured to increase and decrease a pulse rate of the light source and a rotation speed of the motor.

3. The beam steering control system of claim 1, wherein the slow axis controller is communicatively coupled to a rotatable mirror, wherein the slow axis controller is configured to increase and decrease a rotation rate of the rotatable mirror.

4. The beam steering control system of claim 1, wherein the slow axis controller is configured to compensate for disturbances.

5. The beam steering control system of claim 1, wherein the fast axis controller is configured to compensate for rotational vibration by controlling a pulse rate of a light source.

6. The beam steering control system of claim 1, wherein the first axis component is a horizontal component of the light pattern, wherein the second axis component is a vertical component of the light pattern.

7. The beam steering control system of claim 1, further comprising:
a light source configured to emit light for creating the light pattern and controllably coupled to the fast axis controller;
a reflecting apparatus controllably coupled to the fast axis controller; and
a mirror controllably coupled to the slow axis controller.

8. The beam steering control system of claim 7, wherein the mirror is arranged to reflect the emitted light from the light source to the reflecting apparatus.

9. The beam steering control system of claim 7, wherein the reflecting apparatus includes a rotating component with multiple facets.

10. The beam steering control system of claim 9, wherein the mirror is a rotatable mirror.

11. A method comprising:
determining a size and a position of a region of interest in terms of a first coordinate system at a first point in time;
based on position data in terms of a second coordinate system associated with a measurement device with a light source, determining the position of the region of interest in terms of the first coordinate system at later points in time; and
steering emitted light from the light source within the region of interest at the later points in time.

12. The method of claim 11, wherein the first coordinate system is a global coordinate system.

13. The method of claim 11, wherein the determining the position of the region of interest in terms of the first coordinate system at the later points in time is further based on position data is terms of the first coordinate system.

14. The method of claim 11, wherein the determining the position of the region of interest in terms of the first coordinate system at the later points in time is based on transforming the position data of the first coordinate system into position data of the second coordinate system.

15. The method of claim 11, further comprising:
emitting light from the light source towards an object; and
sensing, by an optical detector, backscattered light from the object.

16. The method of claim 15, further comprising:
in response to sensing the backscattered light, detecting the position of object before determining the size and the position of the region of interest.

17. The method of claim 11, wherein the steering emitted light from the light source within the region of interest at the later points in time includes emitting pulsed light such that the light pulses at least partially overlap each other in a vertical and/or horizontal direction.

18. The method of claim 11, wherein the steering emitted light from the light source within the region of interest at the later points in time includes emitting pulsed light along a light pattern with horizontal foveation.

19. A method for generating a light pattern, the method comprising:
measuring a timing from a beginning of a horizontal scan line to an end of the horizontal scan line, which comprises light pulses;
counting down a delay until a next light pulse;
when the delay counter reaches zero, firing a light pulse from a light source;
defining windows of time for a given scan;
defining a priority hierarchy for active windows for a particular timer count; and
for active windows, set a light fire delay to a specified rate.

20. The method of claim 19, further comprising:
dithering the light fire delay.
